(19) United States
(12) Patent Application Publication
(10) Pub. No.: US 2016/0311404 A1
(43) Pub. Date: Oct. 27, 2016

(54) SYSTEM FOR WIPING A VEHICLE WINDSHIELD

(71) Applicant: VALEO SYSTÈMES D'ESSUYAGE, Le Mesnil Saint Denis (FR)

(72) Inventors: Pierre Sevellec, Cournon (FR); Giuseppe Grasso, Le Breuil sur Couze (FR)

(73) Assignee: Valeo Systèmes d'Essuyage, Le Mesnil Saint Denis (FR)

(21) Appl. No.: 15/105,780

(22) PCT Filed: Dec. 4, 2014
(86) PCT No.: PCT/EP2014/076492

§ 371 Date: Jun. 17, 2016

(30) Foreign Application Priority Data
Dec. 20, 2013 (FR) 1363257

(51) Int. Cl. B60S 1/52; B60S 1/38; B60S 1/48; B60S 1/42

(52) U.S. Cl. CPC B60S 1/524; B60S 1/42; B60S 1/38; B60S 1/487; B60S 2001/4096

(57) ABSTRACT

The invention relates to a system for wiping a vehicle windshield including a windshield wiper brush (1), an arm (2) for driving said brush, and means (4, 12) for connecting and hinging the brush (1) to one end of the arm (2). Said brush (1) comprises a wiping blade (5). Said connecting and hinging means (4, 12) include a means (13) for spraying window-cleaning liquid (13). Said system is characterized in that said spraying means (13) comprises: a first spraying means (15-15a) on one longitudinal portion of the blade (5) extending between the connecting and hinging means (4, 12) and a first longitudinal end (1A) of the blade (5); and a second spraying means (16-16a) on another longitudinal portion of the blade (5) extending between the connecting and hinging means (4, 12) and a second longitudinal end (1B) of the blade (5).

### FIELD OF THE INVENTION

The present invention pertains to the field of cleaning a window of a vehicle, especially an automobile. More particularly, it deals with a system for wiping a vehicle window, of the type comprising a window wiper brush and an arm for driving this brush.

### PRIOR ART

A window wiper brush generally comprises a longitudinal body carrying a wiper blade, generally made of rubber, designed to rub against the windshield of a vehicle to remove water by bringing it outside the field of vision of the driver. The brush is carried by an arm which is driven by a motor in an angular back and forth motion. The means of connecting and hinging of the brush to the arm generally comprise a connection device linked to the brush and which fits into a terminal piece fixed to one end of the arm. Moreover, the opposite end of the arm is articulated to the vehicle and coupled to the engine.

To improve the cleaning of a windshield, it is known to atomize the window washing liquid with a least one spraying means. A spraying means generally comprises a spray nozzle commonly fixed to the body of the vehicle and spraying liquid onto the windshield when a washing operation is activated by the driver of the vehicle.

It is preferable to spray liquid onto the windshield in advance of the brush so that the latter quickly removes it in passing, and to thus decrease the time during which the visibility of the driver might be hampered. This is hard to do in optimal fashion by spraying liquid from the body and in general the liquid consumption is large in order to sprinkle the entire surface of the windshield wiped by the brush.

In the prior art, alternative solutions utilize spray nozzles fixed to the brush or to its driving arm, to atomize the window washing liquid as close as possible to the wiper blade of the brush, in advance of the latter in its direction of movement, and thus optimize the efficiency of use of the liquid.

Document FR-A1-2952883 describes a window wiper brush of which a longitudinal end carries a cap which integrates a conduit equipped with a spray nozzle situated close to the wiper blade of the brush. The spray nozzle sprays liquid onto the lip of the wiper blade, so that it is distributed along its length. However, the jet of liquid needs to be powerful enough for the liquid to be distributed uniformly over the entire length of the blade. This necessitates a precise adjustment of the spray nozzle and a system for bringing liquid to the end of the brush, which needs to perform well, especially if the brush is of long length.

Other known solutions consist in distributing spray nozzles along the entire length of the brush, such as in an Aquablade™, for example, so as to distribute the window washing liquid uniformly along the entire length of the brush. However, these solutions are relatively costly.

Yet other solutions, such as those described in the documents FR-A1-2859963, DE-A1-102004007351 and WO-A1-2012/144547, spray window washing liquid from the arm for driving the brush. The spraying of the liquid is done in several jets, whose points of impact are situated on the windshield. In this case, it is hard to ensure a homogeneous distribution of the liquid over the entire length of the wiper blade. For this, it would be necessary to correctly adjust the inclination of the different jets, as well as the distribution of their speeds as a function of the length of the brush and the position of the means of spraying, which is relatively complex. Furthermore, it may prove to be difficult to sufficiently wet the windshield directly in front of the wiper blade, over essentially the entire length of the brush.

The invention proposes a simple, effective and economical solution for at least some of the problems of the prior art. In particular, its purpose is a wiping system having means of spraying of liquid which ensure a good distribution of liquid over essentially the entire length of the brush.

### PRESENTATION OF THE INVENTION

The invention proposes for this effect a system of wiping of a vehicle window, comprising a window wiper brush, an arm for driving said brush, and means of connecting and hinging the brush to one end of the arm, said brush having a wiper blade, and said means of connection and hinging comprising means of spraying of window washing liquid. This system is distinguished in that said means of spraying comprise at least a first means of spraying on a longitudinal portion of the blade extending between the means of connection and hinging and a first longitudinal end of the blade, and a second means of spraying on another longitudinal portion of the blade extending between the means of connection and hinging and a second longitudinal end of the blade.

The window according to the invention can be in particular a windshield or a rear window of a vehicle, especially an automobile.

According to the invention, the means of spraying dispatch window washing liquid to the blade, on either side of the means of connection and hinging. The liquid is thus able to flow by a “gutter effect” along the blade as far as the ends of the brush. In this way, the blade can be wetted over essentially its entire length, which makes it possible to optimize the cleaning of the window and limit the consumption of liquid.

Another advantage of the invention is the fact that the means of spraying are situated in the area of the connection between the brush and the arm. This makes it possible to bring window washing liquid to the means of spraying by simply following the arm and to avoid the integrating of complex liquid channels in the brush.

Preferably, said means of spraying are cantilevered on the means of connection and hinging. This enables more possibilities and freedoms for the direction(s) of spraying of the liquid. The means of spraying can be situated as close as possible to the blade.

Advantageously, each of said first and second means of spraying comprises at least one liquid spraying orifice. Preferably, the or each spraying orifice is disposed essentially in a longitudinal plane passing through the wiper blade and perpendicular to a median longitudinal plane of symmetry of said wiper blade. Insofar as it is desired for the jet to impact against the blade, this makes it possible to orient it essentially horizontal to the blade.

In familiar fashion, the wiper blade comprises a lip and a heel which are joined together by a hinge and an abutment element of the lip, which cushions its return. The or each spraying orifice can be disposed in a longitudinal plane which passes through the lip, the hinge or the abutment element of the blade, and which is perpendicular to the median longitudinal plane of symmetry of said wiper blade. This plane of symmetry can be the median longitudinal plane of the brush.

Preferably, the or each spraying orifice is disposed essentially in a plane parallel to the median plane of symmetry and passing through the wiper brush. This arrangement brings the orifice closer to the blade. On the one hand, this allows more precise aiming of the blade. On the other hand, by decreasing the free distance of the jet, it is easier to ensure that it remain coherent and straight. This prevents the jet from being dispersed in droplets which might be squirted onto portions of the window interfering with the visibility of the driver, and it decreases the consumption of window washing liquid.

Said first and second spraying means can each comprise at least one arched or bent emptying conduit forming said at least one orifice. Preferably, each conduit comprises an essentially straight terminal portion making an angle with the median plane of symmetry. This angle can be determined so that the jet line, prolonging said terminal portion encounters the blade in the vicinity of the means of connection and hinging.

Advantageously, the first means of spraying are configured to spray the liquid at a longitudinal distance d1 from the means of connection and hinging, this distance d1 representing between 1 and 20% of the longitudinal dimension of said first longitudinal portion of the blade, measured from said means of connection and hinging, and/or the second means of spraying are configured to spray the liquid at a longitudinal distance d2 from the means of connection and hinging, this distance d2 representing between 1 and 20% of the longitudinal dimension of said second longitudinal portion of the blade, measured from said means of connection and hinging.

This makes it possible to wet the wiper blade over a large length by these first and second means of spraying. In particular, when the means of spraying are supplied with an adapted pressure and flow rate, liquid from each jet can reach the longitudinal end of the wiper blade toward which it is pointed. In this configuration, the form of the conduits allows a solid jet to be formed, which avoids dispersing the liquid in droplets outside of their targets.

Preferably, the means of connection and hinging are positioned essentially at the longitudinal center of said window wiper brush.

Advantageously, said means of connection and hinging contain a terminal piece integrated with said end of the arm, this terminal piece carrying said means of spraying. In particular, said conduit of each of the first and second means of spraying can contain an end connected to said terminal piece. Moreover, said terminal piece could contain means of connecting the means of spraying to a source of liquid.

In this way, the fluidic communications for supplying the means of spraying can be installed once and for all and the design of the brush is simplified. Moreover, the procedure for changing a brush does not have to take account of connections joined to the supply unit of the means of spraying of liquid.

Advantageously, said means of connection and hinging, contain a connection device integrated with the brush and cooperating with said terminal piece.

This makes it possible to render the means of spraying of liquid independent of the wiper brush. In particular, the means of spraying of liquid can be configured so as to allow disengaging the brush from the terminal piece without removing the means of spraying.

The system can furthermore include means of heating, especially of the window washing liquid.

### BRIEF DESCRIPTION OF THE FIGURES

The present invention will be better understood and further details, characteristics and benefits thereof will appear more clearly from a perusal of the following description, given as a nonlimiting example and making reference to the enclosed drawings, in which:

FIG. 1 presents a schematic perspective view of systems of wiping of a window of an automobile.

FIG. 2 shows a basic diagram of a system of wiping according to the invention, seen in a direction essentially perpendicular to the window.

FIG. 3 shows a front view in the longitudinal direction of a driving arm and a window wiper brush according to the invention.

### DETAILED DESCRIPTION OF THE INVENTION

In the following description, the terms longitudinal or lateral refer to the orientation of a window wiper brush. The longitudinal direction corresponds to the principal axis of the brush in which it extends, while the lateral orientations correspond to concurrent lines, that is, lines which intersect the longitudinal direction, which are in particular perpendicular to the longitudinal axis of the brush. For the longitudinal directions, the terms exterior or interior are related to the point of fixation of the arm to the vehicle, the term interior corresponding to the end of the arm fixed to the vehicle. Finally, the directions referenced as upper or lower correspond to orientations perpendicular to the plane of rotation of the brush, the term lower containing the plane of the window.

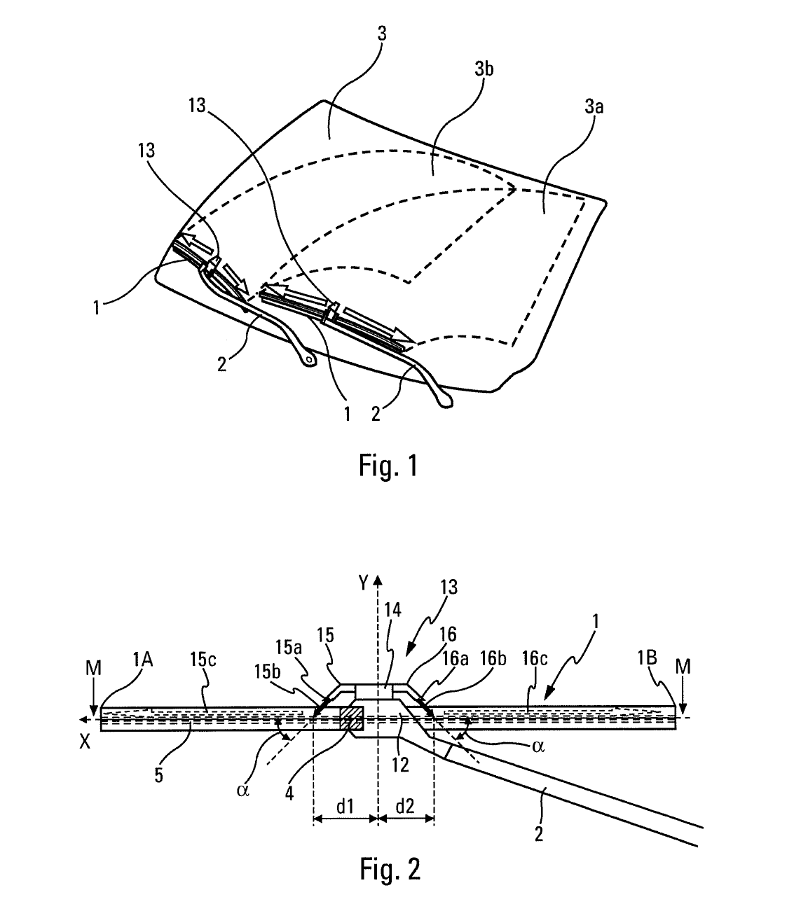

First of all, consider FIG. 1, which represents a system of wiping of a window 3 of an automobile, and in this example a windshield 3 of an automobile. This system comprises here two window wiper brushes 1, which are each driven by an arm 2 in an angular back and forth motion about an axis of rotation of the arm 2. Each brush 1 is thus moved over a surface portion 3a, 3b of the windshield 3, which is schematically bounded by the broken lines in FIG. 1.

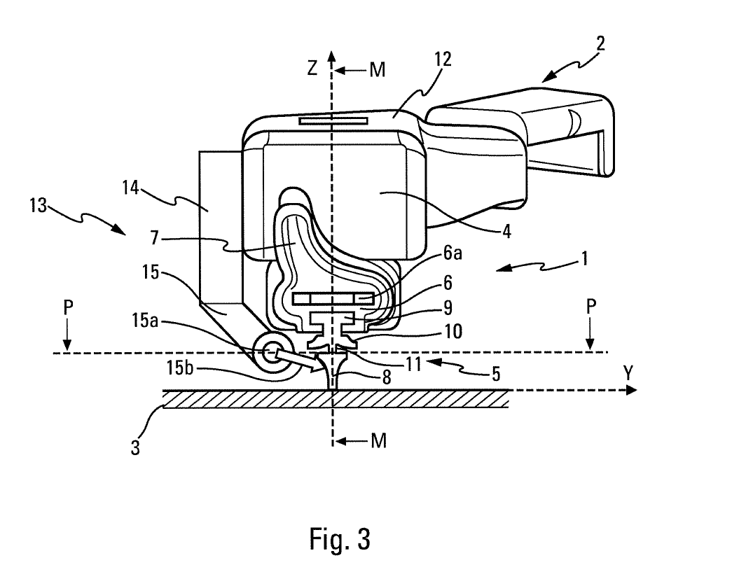

FIGS. 2 and 3 represent one embodiment of a wiping system comprising a window wiper brush 1 and an arm 2 for driving this brush. In typical fashion, the brush 1 has an elongated shape in a longitudinal direction X, essentially perpendicular to a direction Y of progression over the windshield 3, and it is maintained at one end of the arm 2 by a connection device 4, generally situated at roughly the middle of the brush 1.

In typical fashion, referring to FIG. 3, the window wiper brush 1 has in particular a wiper blade 5, generally made of rubber, designed to rub against the windshield 3, a body 6 to support the blade 5, generally carrying a bending spine 6a and joined to the connection device 4, and a deflector 7.

The blade 5 basically comprises four parts, following a direction Z perpendicular to the windshield 3 or to the directions X and Y, and oriented vertically:
a doctor lip 8, designed to be in contact with the windshield 3;
a heel 9 fixing the blade 5 to the body 6 of the brush 1;
a hinge 11 allowing a return of the lip 8 to the front or back, depending on the direction of progression of the brush 1; and
an element 10 cooperating by abutment with the lip 8 during its return, to thus limit its travel to the front and back.

In known manner, the lip 8 is connected to the heel 9 by the hinge 11 and the abutment element 10. Furthermore, the brush 1 has a median longitudinal plane M which is essentially the plane of symmetry of the wiper blade 5. As can be seen in FIG. 3 in particular, this median plane M passes through the middle of the lip 8, of the hinge 11, of the abutment element 10 and of the heel 9.

Each brush 1 comprises a connection device 4 for connection to its driving arm 2 which cooperates with a terminal piece 12 of the arm 2, to provide a link, generally movable, so as to allow the replacement of the brush 1 when it is worn out.

According to the invention, the terminal piece 12 of the arm 2 supports means of spraying 13 of liquid, in particular window washing liquid, onto the blade 3. These means of spraying 13 extend here in cantilevered manner on the terminal piece 12 of the arm 2, as can be seen in FIGS. 2 and 3.

In the example presented here, the terminal piece 12 encloses the connection device 4 of the brush 1. In particular, this connection device 4 can remain confined between two planes parallel to the median plane of symmetry M passing through the interior of the terminal piece 12. This allows here the fixing to this terminal piece 12 of a support 14, belonging to the means of spraying 13, which descends to the area of the brush 1, on the front side when the latter is ascending on the windshield 3. The means of spraying 13 are divided here into a first and a second means of spraying, in the form of two conduits 15, 16, which emerge from the lower end of the support 14, one 15 in the direction of the exterior longitudinal end 1A of the brush 1, the other in the direction of the interior longitudinal end 1B of the brush 1. The support 14 comprises means of channeling, not shown, which feed these conduits 15, 16.

As represented in FIG. 3, the conduit 15 descends further from the support 14 to position an orifice 15a for spraying liquid in a longitudinal plane P perpendicular to the median longitudinal plane M of the brush 1, which passes through the wiper blade 5. It can also be said that, in the example shown, the plane P passes essentially through the hinge 11 or the upper end of the lip 8. Variants can be imagined where this plane P can pass instead in the area of the abutment element 10. Moreover, still referring to FIG. 3, the orifice 15a is brought closer to the median plane M of the brush 1 than the support 14. It is positioned here essentially in the area of the lateral front edge of the body 6.

The conduit 16 and the orifice 16a, not visible in FIG. 3, are positioned in the same way as the conduit 15 and the orifice 15a in the plane of FIG. 3. This arrangement allows the spraying orifices 15a, 16a to be brought closer to the wiper blade 5 while allowing a disengaging of the brush 1, with its connection device 4, from the terminal piece 12 of the arm 2 to replace it when necessary.

Other geometries of the terminal piece 12 and the connection device 4 than those presented schematically in the figures can be contemplated. However, the terminal piece 12 of the arm 2 being exterior to the brush 1, the skilled person will always design a support 14 emerging from the terminal piece 12 and skirting the brush 1 so as to position the spray orifices 15a, 16a as close as possible to the wiper blade 5.

According to a second aspect of the invention, which can be seen in FIG. 2, each conduit 15a, 16a, after a first portion extending basically longitudinally from the support 14, forms a bend before its end in order to direct a jet of liquid 15b, 16b toward the blade 5 (which will then flow by the gutter effect along the blade, as represented in broken lines by the arrows 15c, 16c), making an angle α other than zero with the median plane M of the brush 1. The angle α here is measured in the plane of the drawing, which is a plane perpendicular to the median plane M. Accordingly, as is indicated in FIGS. 2 and 3, the jet 15b impacts on the blade 5, preferably in the area of the lip 8, and at a distance d1 from the connection device 4. In symmetrical fashion, the jet 16b impacts on the lip 8 at a distance d2 from the connection device 4.

The distance d1 represents here between 1 and 20% of the longitudinal dimension of the first longitudinal portion (to the left in the drawing) of the blade, measured from the connection device 4. The distance d2 represents here between 1 and 20% of the longitudinal dimension of the second longitudinal portion (to the right in the drawing) of the blade, measured from the connection device 4. The distances d1 and d2 are essentially identical, for example. More preferably, the distances d1 and d2 are chosen so as to divide the quantities of water proportionately to the surface swept by the corresponding brush portions, or else as a function of the position of the brushes during the sweeping. For example, when the brushes pass in a vertical position (that is, a position “opposite the fixed stop”, or “outwipe”), it is advantageous to provide more water on said first longitudinal portion (to the left in the drawing) than on said second longitudinal portion (to the right in the drawing) of the blade.

The terminal shapes of the conduits 15, 16 and their orifices 15a, 16a are designed to produce a liquid jet 15b, 16b as close to rectilinear as possible. Moreover, the shape of the conduits 15, 16 is determined so that the distances d1 and d2 of the points of impact of the jets 15a, 15b at the center of the means of spraying 13 are the shortest possible.

In this way, when the means of spraying 13 are fed with liquid with a pressure and flow rate adapted to their shape, the liquid coming from the jet 15b, 16b emerging from each spray orifice 15a, 16a is guided along the blade 5 after its impact, as far as each longitudinal end 1A, 1B of the brush 1, as is represented by the arrows 15c and 16c in FIG. 2. The liquid arriving in the form of a coherent jet 15b, 16b at the point of impact and then following the blade 5, there is little or no dispersion of the liquid in the form of droplets outside of the zone of the windshield 3 wetted in the area of the blade 5.

The means of spraying 13 are supplied by a system not shown, comprising in particular one or more pumps providing the adapted pressure and flow rate, a liquid reservoir and means of channeling, especially along the arm 2 to feed the spraying means of the terminal piece 12. As can be noted, none of these means involves the window wiper brush 1. Thus, it is possible to design the wiping system with a first portion formed by the brush 1 and a second portion formed by the arm 2 with the spraying means 13 on the other hand, so that the two portions can be replaced independently of each other without involving the means of channeling of the window washing liquid.

The configuration shown is not limiting of the embodiments of the invention. The spraying means 13 can have a plurality of orifices and send two lateral jets, for example, in one direction, instead of a single one to distribute the liquid along the wiper blade 5 as far as a longitudinal end 1A, 1B. There can also be a central spray orifice, spraying liquid onto the blade 5 to the right of the spraying means 13 in order to more efficiently wet the central portion between the points of impact of the lateral jets 15b, 16b.

It is equally possible, for example, to contemplate a symmetrical system spraying liquid on both sides of the brush 1, that is, in the ascending and descending directions of movement of the brush. The spraying of window washing liquid can be done during the movement of the brush 1 or prior to a movement of the brush. The connection device 4 of the brush 1 can also be heated by appropriate heating means, to heat the window washing liquid before spraying it onto the windshield 3.

1. A system of wiping of a vehicle window, comprising:
a window wiper brush;
an arm for driving said brush; and
means of connecting and hinging the brush to one end of the arm, said brush having a wiper blade, and said means of connection and hinging comprising means of spraying of window washing liquid,
wherein said means of spraying comprise at least a first means of spraying on a longitudinal portion of the blade extending between the means of connection and hinging and a first longitudinal end of the blade, and a second means of spraying on another longitudinal portion of the blade extending between the means of connection and hinging and a second longitudinal end of the blade.

2. The system as claimed in claim 1, wherein said means of spraying are cantilevered on said means of connection and hinging.

3. The system as claimed in claim 1, wherein each of said first and second means of spraying comprises at least one liquid spraying orifice.

4. The system as claimed in claim 3, wherein the or each spraying orifice is disposed essentially in a longitudinal plane passing through the blade and perpendicular to a median longitudinal plane of symmetry of said blade.

5. The system as claimed in the preceding claim 4, wherein the blade, comprising a lip and a heel which are joined together by a hinge and an abutment element of the lip, the or each spraying orifice is disposed essentially in a longitudinal plane WPM which passes through the lip, the hinge or the abutment element of the blade, and which is perpendicular to said median longitudinal plane of symmetry.

6. The system as claimed in claim 3, wherein the or each spraying orifice is disposed essentially in a plane parallel to the median plane of symmetry and passing through the wiper brush.

7. The system as claimed in claim 3, wherein said first and second spraying means each comprise at least one arched or bent emptying conduit forming said at least one orifice.

8. The system as claimed in claim 7, wherein each conduit comprises an essentially straight terminal portion making an angle other than zero with the median plane of symmetry.

9. The system as claimed in claim 8, wherein said angle is determined so that the jet line prolonging said terminal portion encounters the blade in the vicinity of the means of connection and hinging.

10. The system as claimed in claim 7, wherein said means of connection and hinging contain a terminal piece integrated with said end of the arm, this terminal piece carrying said means of spraying.

11. The system as claimed in claim 10, wherein said conduit of each of the first and second means of spraying contains an end connected to said terminal piece.

12. The system as claimed in claim 10, wherein said terminal piece contains means of connecting the means of spraying to a source of liquid.

13. The system as claimed in claim 10, wherein said means of connection and hinging contain a connection device integrated with the brush and cooperating with said terminal piece.

14. The system as claimed in claim 1, wherein the means of connection and hinging are positioned essentially at the longitudinal center of said window wiper brush.

15. The system as claimed in claim 1, further comprising means of heating said liquid.
